(19) United States
(12) Patent Application Publication
(10) Pub. No.: US 2023/0105112 A1
(43) Pub. Date: Apr. 6, 2023

(54) METHOD, APPARATUS AND RECORDING MEDIUM FOR ENCODING/DECODING FEATURE MAP

(71) Applicant: Electronics and Telecommunications Research Institute, Daejeon (KR)

(72) Inventors: Youn-Hee KIM, Daejeon (KR); Ji-Hoon DO, Daejeon (KR); Se-Yoon JEONG, Daejeon (KR); Joo-Young LEE, Daejeon (KR); Hyoung-Jin KWON, Daejeon (KR); Dong-Hyun KIM, Daejeon (KR); Jong-Ho KIM, Daejeon (KR); Woong LIM, Daejeon (KR); Jin-Soo CHOI, Daejeon (KR); Tae-Jin LEE, Daejeon (KR); Dong-Gyu SIM, Seoul (KR); Min-Sub KIM, Seoul (KR); Seung-Jin PARK, Guri-si Gyeonggi-do (KR); Seoung-Jun OH, Seongnam-si Gyeonggi-do (KR); Min-Hun LEE, Uijeongbu-si Gyeonggi-do (KR); Han-Sol CHOI, Dongducheon-si Gyeonggi-do (KR)

(73) Assignee: Electronics and Telecommunications Research Institute, Daejeon (KR)

(21) Appl. No.: 17/960,639

(22) Filed: Oct. 5, 2022

(30) Foreign Application Priority Data
Oct. 6, 2021 (KR) 10-2021-0132675
Jan. 12, 2022 (KR) 10-2022-0004441
Feb. 16, 2022 (KR) 10-2022-0020139
Sep. 7, 2022 (KR) 10-2022-0113547

(51) Int. Cl. H04N 19/61; G06V 10/77; G06V 10/82

(52) U.S. Cl. CPC H04N 19/61; G06V 10/7715; G06V 10/82

(57) ABSTRACT

Disclosed herein is an encoding method. The encoding method includes generating multiple feature maps using an input image, transforming the feature maps using a transform vector, and generating a bitstream by performing entropy encoding on at least any one of the feature map, the transform coefficient of the feature map, or the transform vector, or a combination thereof.

### CROSS REFERENCE TO RELATED APPLICATIONS

This application claims the benefit of Korean Patent Application No. 10-2021-0132675, filed Oct. 6, 2021, No. 10-2022-0004441, filed Jan. 12, 2022, No. 10-2022-0020139, filed Feb. 16, 2022, and No. 10-2022-0113547, filed Sep. 7, 2022, which are hereby incorporated by reference in their entireties into this application.

### BACKGROUND OF THE INVENTION

### 1. Technical Field

The present invention relates to a method, apparatus, and recording medium for encoding/decoding an image. More particularly, the present invention relates to a method, apparatus, and recording medium for encoding/decoding a feature map for performing a machine task.

### 2. Description of the Related Art

A Video Coding for Machines (VCM) encoder encodes input image information or feature map information extracted from the input image information and transmits the encoded input image information or the encoded feature map information.

A VCM decoder receives a bitstream of image information or feature map information as the input thereof and outputs image information that is reconstructed using the input bitstream. Also, the decoder performs one or multiple tasks according to an application using feature map information that is reconstructed using the input bitstream.

### DOCUMENTS OF RELATED ART

(Patent Document 1) Korean Patent Application Publication No. 10-2021-0062346, titled “AI node and method for compressing feature map thereof”.

### SUMMARY OF THE INVENTION

An object of the present invention is to provide a method, apparatus, and recording medium for encoding/decoding a feature map for performing a machine task.

Another object of the present invention is to improve encoding and decoding efficiency by reducing the amount of transmitted feature maps or the amount of transmitted basis vectors.

In order to accomplish the above objects, an encoding method according to an embodiment of the present invention includes generating multiple feature maps using an input image, transforming the feature maps using a transform vector, and generating a bitstream by performing entropy encoding on at least any one of the feature map, the transform coefficient of the feature map, or the transform vector, or a combination thereof.

Here, generating the bitstream may include packing at least any one of the feature map, the transform coefficient of the feature map, or the transform vector, or a combination thereof.

Here, generating the multiple feature maps may comprise using an artificial neural network structure configured with multiple layers.

Here, generating the multiple feature maps may comprise extracting some of feature maps corresponding to the multiple layers.

Here, generating the multiple feature maps may comprise generating a differential feature map between a predicted feature map and an original feature map.

Here, transforming the feature map may include forming a transform unit group including one or more transform units, and the transform unit may correspond to a sub-feature map of the feature map.

Here, the transform vector may be set to correspond to the transform unit group.

Here, transforming the feature map may include down-sampling or up-sampling the transform unit when the size of the transform vector differs from the size of the transform unit.

Also, in order to accomplish the above objects, a decoding method according to an embodiment of the present invention includes reconstructing information about at least any one of a feature map, the transform coefficient of the feature map, or a transform vector, or a combination thereof by performing entropy decoding on a bitstream, inversely transforming the transform coefficient using a reconstructed transform vector, and reconstructing multiple feature maps using an inversely transformed feature map.

Here, reconstructing the information may include separating and inversely arranging a data group in the bitstream.

Here, reconstructing the multiple feature maps may comprise using an artificial neural network structure configured with multiple layers.

Here, reconstructing the multiple feature maps may comprise reconstructing other feature maps using the inversely transformed feature map.

Here, the feature map may correspond to a differential feature map between a predicted feature map and an original feature map.

Here, inversely transforming the transform coefficient may comprise inversely transforming each transform unit group including one or more transform units, and the transform unit may correspond to a sub-feature map of the feature map.

Here, the transform vector may be set to correspond to the transform unit group.

Here, reconstructing the multiple feature maps may comprise reconstructing other feature maps by up-sampling or down-sampling the inversely transformed feature map.

Here, reconstructing the multiple feature maps may comprise reconstructing other feature maps using a result of performing a convolution operation on the inversely transformed feature map and a residual feature map.

Also, in order to accomplish the above objects, a computer-readable recording medium for storing a bitstream according to an embodiment of the present invention is provided. The bitstream may include the transform coefficient of a feature map and a transform vector, the transform coefficient may be inversely transformed using the transform vector, other feature maps may be reconstructed using an inversely transformed feature map, the transform vector may be set to correspond to a transform unit group, and the transform unit group may include one or more transform units.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating an encoding method according to an embodiment of the present invention;

FIG. 2 is a flowchart illustrating a decoding method according to an embodiment of the present invention;

FIG. 3 is a view conceptually illustrating an encoding process according to an embodiment of the present invention:

FIG. 4 is a view illustrating the structure of a feature map extraction unit;

FIG. 5 is a view illustrating the structure of a feature map subtractor;

FIG. 6 illustrates a process of generating a differential feature map;

FIG. 7 is a view illustrating the structure of a feature map transformer;

FIG. 8 illustrates a transform unit and a transform unit group according to an embodiment;

FIGS. 9 to 12 are examples of input and output of a transform vector derivation unit and a transformation unit according to a transform unit and a transform unit group:

FIG. 13 is a view illustrating the structure of a feature map information packer;

FIG. 14 is a view conceptually illustrating a decoding process according to an embodiment of the present invention;

FIGS. 15 to 16 are examples of the operation of an inverse feature-map transformer according to different inputs;

FIGS. 17 and 18 are examples of generation of other feature maps using a feature map reconstructed in a decoder:

FIG. 19 is a view conceptually illustrating a decoding process according to an embodiment of the present invention; and

FIG. 20 is a view illustrating the configuration of a computer system according to an embodiment

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises.” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”. “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

A system for encoding a feature map according to an embodiment of the present invention performs a preprocessing procedure, such as transformation, quantization, and packing, on a feature map and encodes the feature map, thereby outputting a bitstream. Also, a system for decoding a feature map according to an embodiment performs decoding, depacking, dequantization, inverse transformation, and the like on a bitstream, thereby reconstructing a feature map.

In the process of transforming and inversely transforming a feature map, multiple transform units having different sizes may share a single basis vector set.

In the encoding/decoding process, different types of encoding/decoding may be performed in units of data groups acquired by grouping feature map information.

After a feature map reconstruction process is completed, the feature map of the same layer or the previous layer may be predicted using the reconstructed feature map.

The present invention aims to improve compression performance by effectively reducing, when transformation is performed, the amount of transmitted basis vectors or the amount of transmitted feature maps while maintaining the performance of a machine task, compared to existing feature map compression technologies. The present invention has the following effects.

In the transformation step of the method according to an embodiment of the present invention, a transform vector sharing unit that is optimal from the aspects of target transformation performance and the amount of transform vector data may be adjusted for each input image.

The method according to an embodiment may perform encoding on a feature map or a transformed domain, and may improve encoding efficiency by implicitly or explicitly selecting an encoder that is optimum for the characteristics of different types of data.

The method according to an embodiment of the present invention may select a feature map that is optimum for the target performance and a bit rate in an encoder, and may encode the same. Also, some of feature maps required for performing a feature map analysis process subsequent to a decoding process are predicted using decoded feature maps, rather than being transmitted, whereby the amount of transmitted feature maps may be reduced.

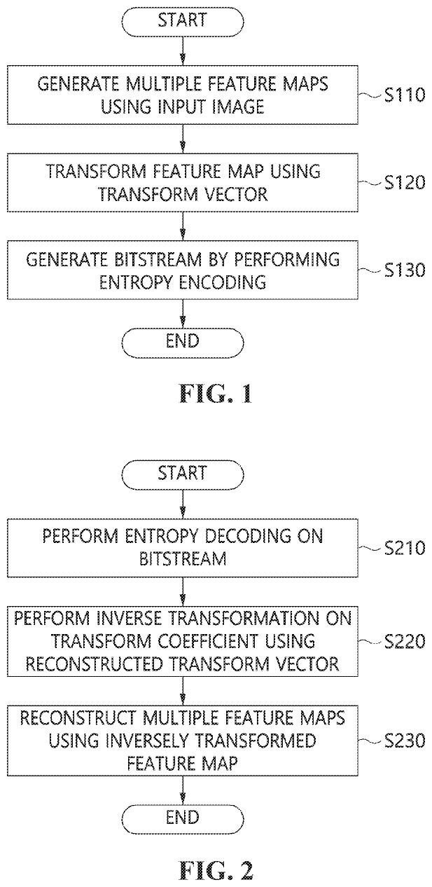

FIG. 1 is a flowchart illustrating an encoding method according to an embodiment of the present invention.

The encoding method according to an embodiment of the present invention may be performed by an encoding apparatus such as a computing device.

Referring to FIG. 1, the encoding method according to an embodiment of the present invention includes generating multiple feature maps using an input image at step S110, transforming the feature map using a transform vector at step S120, and generating a bitstream by performing entropy encoding at least any one of the feature map, the transform coefficient of the feature map, or the transform vector, or a combination thereof at step S130.

Here, generating the bitstream at step S130 may include packing at least any one of the feature map, the transform coefficient of the feature map, or the transform vector, or a combination thereof.

Here, generating the multiple feature maps at step S110 may comprise using an artificial neural network structure configured with multiple layers.

Here, generating the multiple feature maps at step S110 may comprise extracting some of the feature maps corresponding to the multiple layers.

Here, generating the multiple feature maps at step S110 may comprise generating a differential feature map between a predicted feature map and an original feature map.

Here, transforming the feature map at step S120 includes forming a transform unit group including one or more transform units, and the transform unit may correspond to a sub-feature map of the feature map.

Here, the transform vector may be set to correspond to a transform unit group.

Here, transforming the feature map at step S120 may include down-sampling or up-sampling the transform unit when the size of the transform vector differs from the size of the transform unit.

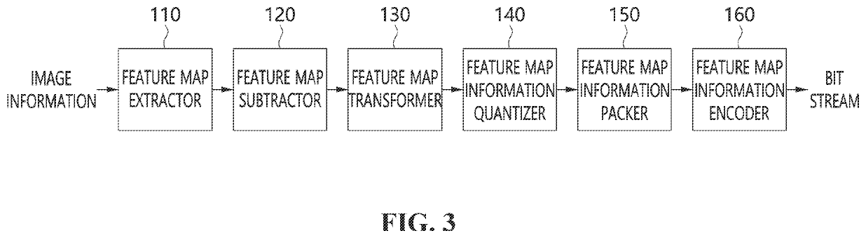

FIG. 2 is a flowchart illustrating a decoding method according to an embodiment of the present invention.

The decoding method according to an embodiment of the present invention may be performed by a decoding apparatus such as a computing device.

Referring to FIG. 2, the decoding method according to an embodiment of the present invention includes reconstructing information about at least any one of a feature map, the transform coefficient of the feature map, or a transform vector, or a combination thereof by performing entropy decoding on a bitstream at step S210, inversely transforming the transform coefficient using a reconstructed transform vector at step S220, and reconstructing multiple feature maps using an inversely transformed feature map at step S230.

Here, reconstructing the information at step S210 may include separating a data group in the bitstream and inversely arranging the same.

Here, reconstructing the multiple feature maps at step S230 may comprise using an artificial neural network structure configured with multiple layers.

Here, reconstructing the multiple feature maps at step S230 may comprise reconstructing other feature maps using the inversely transformed feature map.

Here, the feature map may correspond to a differential feature map between a predicted feature map and an original feature map.

Here, inversely transforming the transform coefficient at step S220 may comprise inversely transforming each transform unit group including one or more transform units, and the transform unit may correspond to a sub-feature map of the feature map.

Here, the transform vector may set to correspond to a transform unit group.

Here, reconstructing the multiple feature maps at step S230 may comprise reconstructing other feature maps by up-sampling or down-sampling the inversely transformed feature map.

Here, reconstructing the multiple feature maps at step S230 may comprise reconstructing other feature maps using a residual feature map and the result of performing a convolution operation on the inversely transformed feature map.

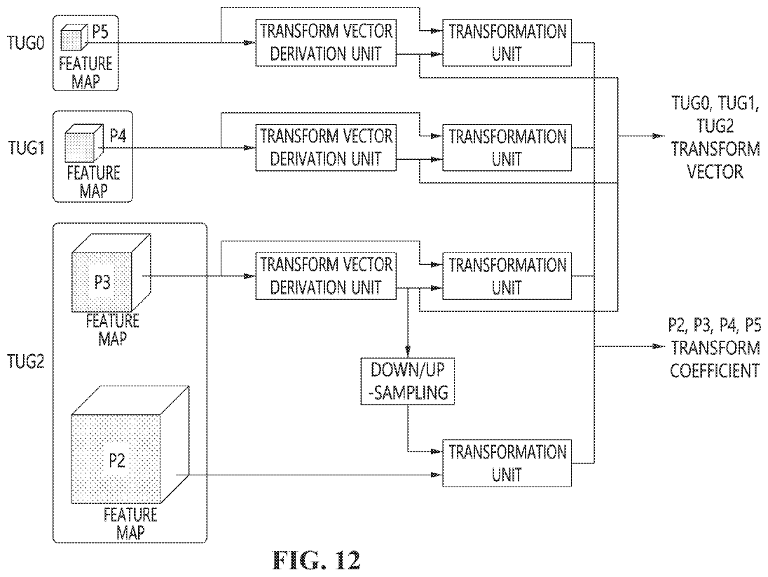

Hereinafter, an encoding method according to an embodiment of the present invention will be described in detail with reference to FIGS. 3 to 13.

FIG. 3 is a view conceptually illustrating an encoding process according to an embodiment of the present invention.

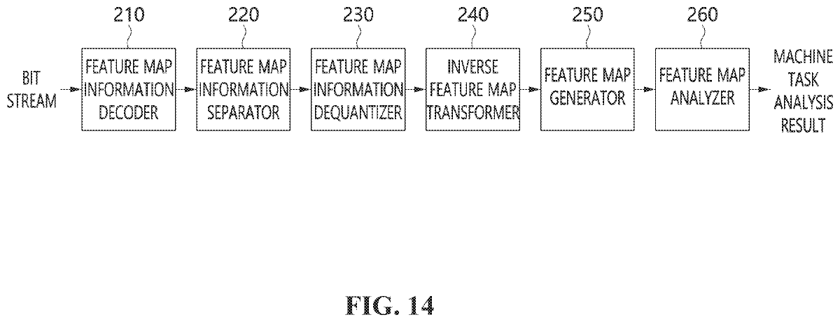

Referring to FIG. 3, the process of generating one or multiple bitstreams by extracting a feature map from video or an image and compressing the same can be seen. The encoding apparatus according to an embodiment may be configured with modules (steps) including a feature map extractor 110, a feature map subtractor 120, a feature map transformer 130, a feature map information quantizer 140, a feature map information packer 150, a feature map information encoder 160, and the like. Here, the respective steps may be skipped, or the order of the steps may be changed. Although described later, a decoder may receive an encoded feature map (or an image/video bitstream) and reconstruct feature map data through a decoding process, and the reconstructed feature map (or image/video) is input to the feature map analyzer 260 in FIG. 14, whereby a final analysis result may be acquired.

The feature map extractor 110 in FIG. 3 receives an image or video and performs part of a neural network, thereby outputting one or multiple feature maps.

Here, the neural network may be configured with a feature map extraction unit and a feature map analysis unit. The feature map extraction unit is configured with one or multiple layers such that one or multiple feature maps are output therefrom, and may be set differently according to an embodiment even though the same neural network is used.

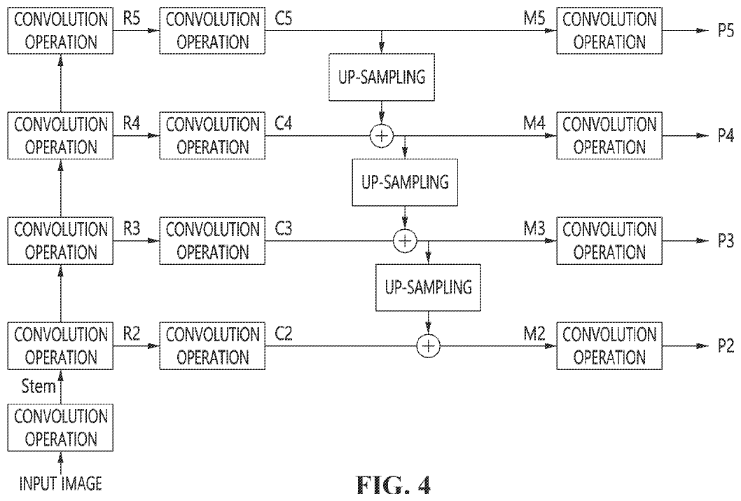

FIG. 4 is a view illustrating the structure of a feature map extraction unit.

Referring to FIG. 4, the feature map extraction unit may be configured with multiple layers. For example, the feature map extraction unit may have a feature pyramid network structure or a structure in which multiple convolutional layers are combined.

In FIG. 4, the first letter (alphabet) of a feature map name denotes a layer in the pyramid structure, and the number after the letter may denote a level in the pyramid structure. For example, R2, R3, R4, and R5 may be feature maps at different levels in the same layer in the pyramid structure. For example, R2, C2, M2, and P2 may be feature maps of different layers at the same level in the pyramid structure. One or more of the final output feature maps or intermediate output feature maps of the feature map extraction unit of the neural network may be selected and output from the feature map extractor. The feature maps of all of the levels of a specific layer of the feature map extraction unit may be output, or the feature maps of different levels in multiple layers may be output. For example, when the feature map extraction unit is configured as shown in FIG. 4, a combination of feature maps, such as (P2, P3, P4, P5), (C2, C3, C4, P5), (C2, C3, C4), or the like, may be output from the feature map extractor.

Here, the number of feature maps (number_of_coded_FM) extracted for a single input image and the feature map index (FM_idx) thereof may be transmitted through a feature map parameter set (featuremap_parameter_set). The feature map parameter set may be transmitted for each input image or video of FIG. 3.

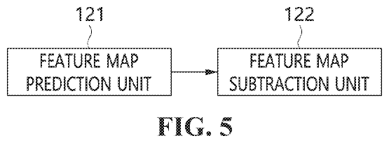

FIG. 5 is a view illustrating the structure of a feature map subtractor.

Referring to FIG. 5, the feature map subtractor 120 may include a feature map prediction unit 121 and a feature map subtraction unit 122.

The feature map subtractor 120 may derive a differential feature map for the feature map extracted from the feature map extractor. When the differential feature map is derived from the feature map, not the original feature map but the differential feature map may be encoded and transmitted at subsequent steps. The flag (is_residual_coded) indicating whether an original feature map or a differential feature map is transmitted for a feature map may be transmitted through a feature map header (featuremap_header).

The feature map prediction unit 121 may generate a predicted feature map of the feature map extracted from the feature map extractor. According to an embodiment, the order may be changed, and some processes may be skipped. In order to generate a predicted feature map, a convolution operation may be performed using one or more convolutional layers.

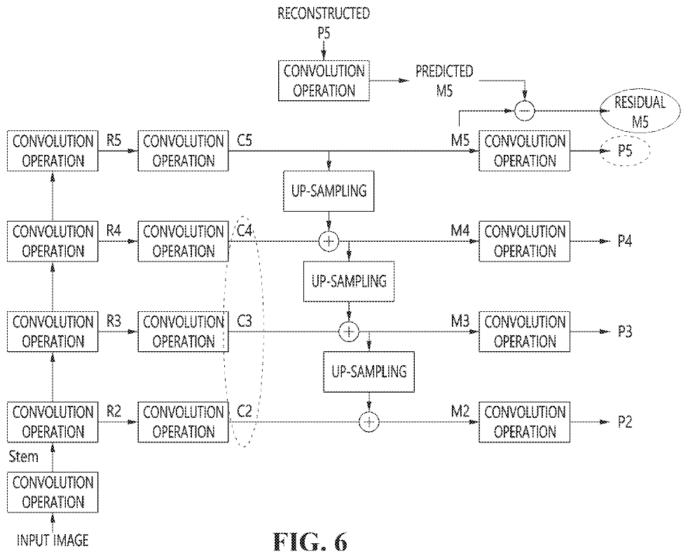

FIG. 6 illustrates a process of generating a differential feature map.

Referring to FIG. 6, it can be seen that a differential feature map is generated for an arbitrary feature map, among the feature maps extracted from the feature map extractor. In the example of FIG. 6, a predicted feature map of the feature map M5 may be generated using a reconstructed feature map P5.

The feature map subtraction unit 122 may derive a differential feature map using a feature map and a predicted feature map, after which the differential feature map may be encoded and transmitted. For example, the differential feature map between M5 and the predicted feature map of M5 may be derived as shown in FIG. 6, and the differential feature map may be encoded and transmitted through subsequent processes.

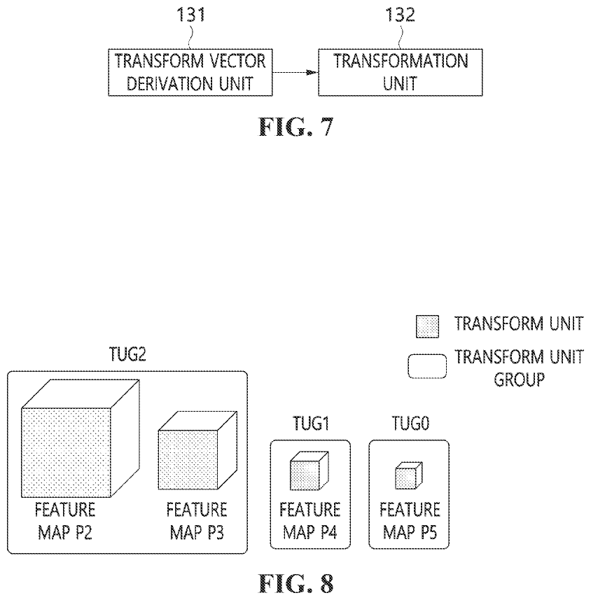

FIG. 7 is a view illustrating the structure of a feature map transformer.

The feature map transformer 130 may transform the feature map extracted from the feature map extractor 110 or the residual feature map generated by the feature map subtractor 120.

Referring to FIG. 7, the feature map transformer may include a transform vector derivation unit 131 and a transformation unit 132. That is, the feature map transformer 130 may transform a transform unit after a transform vector for the transform unit is derived. According to an embodiment, the order may change, and some processes may be skipped.

Here, the transform unit may be a channel (W×H) of a feature map or a sub-feature map having a size of (W/n×H/m), n and m being integers equal to or greater than 1. The sub-feature map may be a segment of the feature map.

FIG. 8 illustrates a transform unit and a transform unit group according to an embodiment.

The transform unit and the transform unit group may be as shown in FIG. 8. All transform units in a transform unit group may be transformed using the same transform vector set (multiple transform vectors). The transform unit group may be configured with transform units included in one or multiple feature maps. For a feature map for which transformation is to be performed, a transform vector may be derived, and transformation may be performed.

Whether to perform transformation may be selected for each feature map, and a flag indicating information thereabout (is_transformed) may be transmitted through a feature map header (featuremap_header).

For each transform unit group, a transform unit group header (TUG_header) and transform vector set information may be transmitted. Through the transform unit group header, a group index (TUG_idx), the size of a transform vector (basis_vector_size_idx), and the number of transform vectors (num_of_basis_vector) may be transmitted. The number of feature maps included in a transform unit group (num_of_belongedFM) and each index (FM_idx) may be transmitted.

When transformation is performed on each feature map, the size of a transform unit (feature_TU_size_idx) and the index of a transform unit group in which the feature map is included (TUG_idx) may be transmitted through a feature map header (featuremap_header). A flag indicating whether a transform coefficient is transmitted (has_coefficient) may be transmitted, and the transform coefficient may be encoded and transmitted depending on the flag.

The transform vector derivation unit 131 may perform the following operation.

The transform vector derivation unit 131 may derive a single transform vector set (multiple transform vectors) for a single transform unit group. The transform vector set may be selected from among multiple transform vector sets that are selected through agreement of an encoder and a decoder, or may be derived by calculating a transform vector set optimum for transform units in the current transform unit group.

When a transform vector set is selected from among the transform vector sets that are selected through agreement of the encoder and the decoder and when multiple transform vector sets are present for one or multiple transform units, an index for the transform vector set and indexes for transform vectors in the transform vector set may be signaled by the encoder.

When a transform vector set is selected from among the transform vector sets that are selected through agreement of the encoder and the decoder and when the transform vector set is fixed for one or multiple transform units, indexes for transform vectors in the transform vector set may be signaled by the encoder.

When a transform vector set is selected from among the transform vector sets that are selected through agreement of the encoder and the decoder, the transform vector set may be selected using a parsed index and used in the transformation unit

When a transform vector for the current transform unit is derived, the optimum transform vector for a transform unit group may be derived using all or some of the transform units in the transform unit group through a method such as PCA or the like according to an embodiment.

Here, when transform units having different sizes are present in a transform unit group, the sizes of all of the transform units are made equal by performing down-sampling to the size of a smaller transform unit or up-sampling to the size of a larger transform unit, and a transform vector may be derived using the transform units.

The transformation unit 132 may perform the following operation.

The transformation unit 132 may perform transformation on a transform unit using the transform vector derived by the transform vector derivation unit 131. According to an embodiment, all transform units in the same transform unit group may be transformed using the same transform vector.

When the size of the derived transform vector differs from that of the transform unit, up-sampling or down-sampling may be performed in order to set the size of the transform vector to be equal to the size of the transform unit.

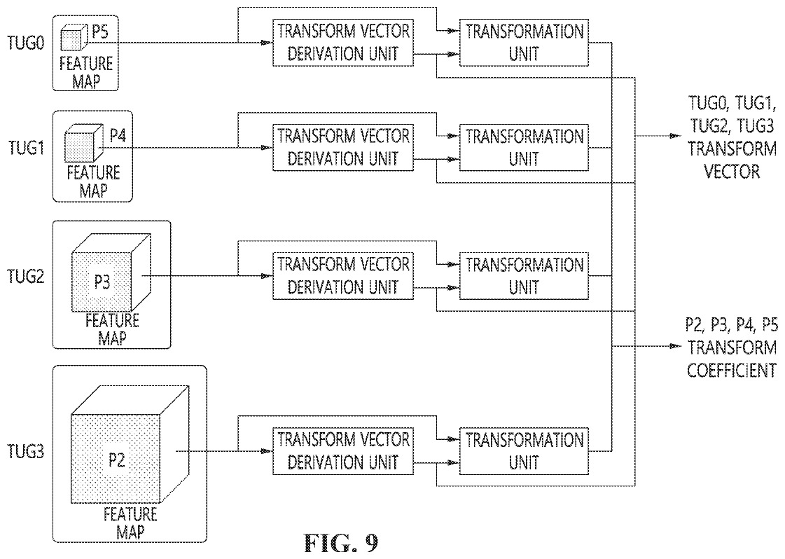

FIGS. 9 to 12 are examples of input and output of a transform vector derivation unit and a transformation unit according to a transform unit and a transform unit group.

FIG. 9 shows an example in which the channels of respective feature maps having different resolutions are transform units and in which each feature map uses an individual transform unit group. Here, the respective feature maps are input to the transform vector derivation unit, whereby multiple transform vectors may be derived. The transformation unit performs transformation on the respective channels using the same transform vector set, thereby outputting a transform coefficient.

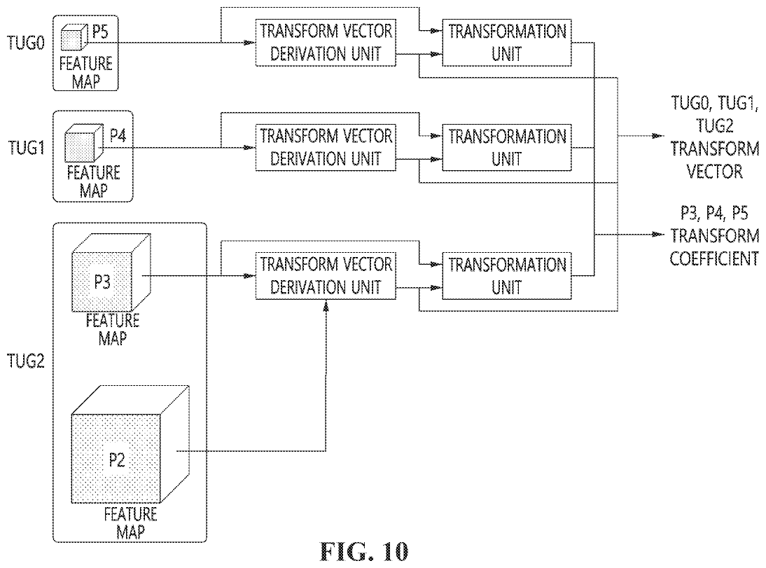

FIG. 10 shows an example in which the channels of respective feature maps having different resolutions are transform units and in which the channels of one or multiple feature maps having different resolutions may be included in each transform unit group. For example, P2 is a feature map that is not transmitted, but (P2, P3) may be a transform unit group. In this case, the transform unit in P2 may also be used in order to derive a transform vector for P3. Before the transform vector is derived, P2 may be down-sampled to the size of P3.

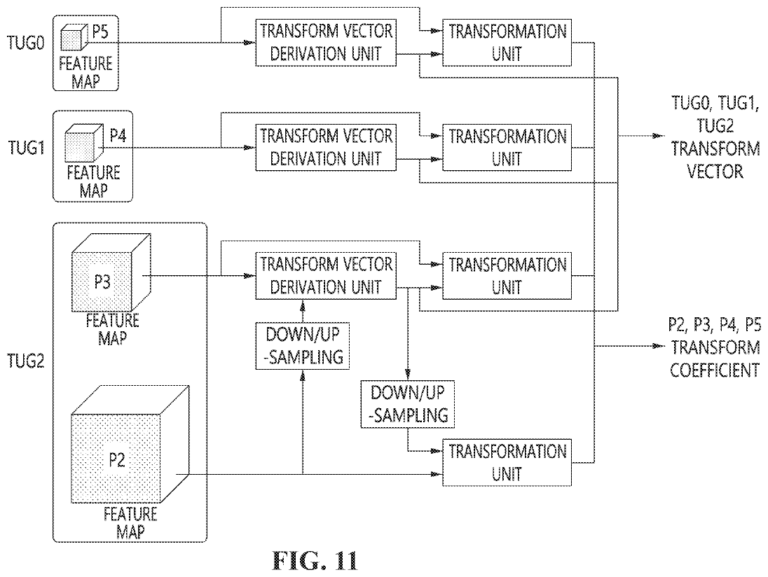

Like FIG. 10, FIG. 11 shows an example in which the channels of respective feature maps having different resolutions are transform units and in which the channels of one or multiple feature maps may be included in a transform unit group. (P2, P3) is a transform unit group, and P2 is down-sampled to the size of P3, after which a transform vector is derived. Transformation is performed on the channels in P3 using the derived transform vector, and transformation is performed on the channels in P2 after the derived transform vector is up-sampled to the size of the channel of P2.

Like FIG. 10, FIG. 11 shows an example in which the channels of respective feature maps having different resolutions are transform units and in which the channels of one or multiple feature maps may be included in a transform unit group. (P2, P3) is a transform unit group, and a transform vector may be derived using only the transform unit in P3. The transform unit in P3 may be transformed using the derived transform vector without change. The transform vector is up-sampled, and the transform unit in P2 may be transformed.

The feature map information quantizer 140 may perform uniform or non-uniform quantization on a feature map, a transform vector, a transform coefficient, and the like. Quantization may be performed separately on different types of data.

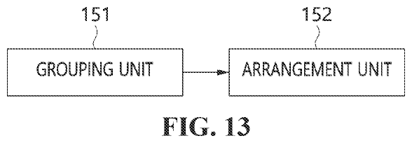

FIG. 13 is a view illustrating the structure of a feature map information packer.

Referring to FIG. 13, the feature map information packer 150 may include a grouping unit 151 and an arrangement unit 152.

The feature map information packer 150 may group one or more feature maps extracted from an image or video, transform vectors, or transform coefficients into multiple data groups and perform arrangement in the data groups. Then, the feature map information encoder 160 corresponding to the subsequent step may select an encoder type for each of the data groups, perform encoding, and generate a single bitstream for each of the data groups.

The grouping unit 151 may play the following role. The same kind of data (e.g., a feature map, a basis vector set, or a transform coefficient) derived from one or more feature maps may be grouped into one or more data groups. For example, the transform coefficients of P2, P3. P4, and P5 may be grouped into a single data group, and the transform coefficients of TUG0, TUG1, and TUG2 may be grouped into a single data group.

The arrangement unit 152 may arrange data in each data group. When one or more feature maps are grouped into a data group, the channels of the feature maps may be arranged in two dimensions according to a specific order of feature maps such that each column includes a specific number of channels. When basis vectors of one or more transform unit groups are grouped into a data group, the basis vectors may be arranged in two dimensions according to the order of indexes in a specific transform unit group such that each column includes a specific number of basis vectors. When the transform coefficients of one or more feature maps are grouped into a data group, the transform coefficients may be aligned in a one-dimensional array according to a specific order of feature maps.

In the above-described packing process, additional information may be transmitted through a data group header (data_group_header). Information (is_arranged) indicating whether arrangement is performed on data derived from a feature map (a feature map, a transform coefficient, or a basis vector set) may be transmitted. When arrangement is performed, an arrangement method (arranging_method_idx) may be transmitted. The type of data grouped into a data group (data_type_idx) may be transmitted.

When a data type is a feature map or a transform coefficient, the number of feature maps from which data is derived (num_of_data_in_data_group_minus1) and the index of each feature map (FM_idx) may be transmitted. When a data type is a basis vector set, the number of transform unit groups to which the basis vector set belongs (num_of_data_in_data_group_minus1) and the index of the transform unit group (TUG_idx) may be transmitted.

The data group in which data is grouped and arranged may be input to the feature map information encoder 160.

The feature map information encoder 160 performs encoding on a feature map, a transform vector, a transform coefficient, or the like, thereby outputting a bitstream. The feature map information encoder 160 may receive, as input, the feature map extracted by the feature map extractor or the differential feature map extracted by the feature map subtractor. Alternatively, the feature map information encoder 160 may receive a transform vector or a transform coefficient, which is transform information of a feature map or a differential feature map, as input.

For the input feature map, transform vector, or transform coefficient, the type of an encoder may be selected. An encoding method agreed on by a transmission apparatus and a reception apparatus is selected depending on a data type (a feature map, a transform vector, or a transform coefficient) or the location of the layer or level from which a feature map is extracted, an encoder is selected based on the result of analyzing the characteristics of data in the encoder, or the encoding method that is optimum from the aspect of bit-performance may be selected after multiple encoders are checked. The selected type of encoder (codec_type_idx) may be transmitted through a data group header (data_group_header).

The types of encoders may include an encoder based on a neural network (an encoder based on an End-to-End NN), an encoder having a structure in which a prediction part and a transformation part are combined (an encoder based on VVC or HEVC as an embodiment), an encoder based on entropy coding (an encoder based on DeepCABAC as an embodiment), and the like. The encoder based on an end-to-end NN may be configured with multiple convolutional layers. The encoder having a structure in which a prediction part and a transformation part are combined may be configured with stages including a prediction unit, a transformation unit, a quantization unit, an entropy coding unit, and the like, for which operation is performed in units of blocks. The encoder based on entropy coding may be configured with stages including a quantization unit, an entropy coding unit, and the like.

Hereinafter, a decoding method according to an embodiment of the present invention will be described in detail with reference to FIGS. 14 to 18.

FIG. 14 is a view conceptually illustrating a decoding process according to an embodiment of the present invention.

Referring to FIG. 14, a decoding apparatus according to an embodiment may be configured with a feature map information decoder 210, a feature map information separator 220, a feature map information dequantizer 230, an inverse feature-map transformer 240, a feature map generator 250, a feature map analyzer, and the like. Here, some of steps corresponding to these blocks may not be performed, or the order thereof may be changed. Here, the decoding apparatus may reconstruct a feature map by decoding one or multiple bitstreams received thereby, analyze a feature map using the reconstructed feature map, and derive a machine task analysis result.

The feature map information decoder 210 performs decoding on each of the received bitstreams, thereby outputting a reconstructed data group. The index of the type of a decoder (codec_type_idx) in a data group header (data_group_header) is parsed, and the bitstream may be decoded using the decoder corresponding to the index. The type of the decoder may be a decoder based on an end-to-end NN, a decoder having a structure in which a prediction part and a transformation are combined (a decoder based on VVC or HEVC), or a decoder based on entropy coding (a decoder based on DeepCABAC).

The feature map information separator 220 may separate the data group reconstructed by the feature map information decoder 210 and inversely arrange data in the form before packing. The data group reconstructed from a single bitstream by the feature map information decoder 210 may include one or more feature maps or the same kind of data extracted from a feature map.

For example, the reconstructed transform coefficients of P2 and P3 may be included in a single reconstructed data group. The reconstructed data group may have a form in which data is arranged in a two-dimensional frame or a one-dimensional array depending on the type of the decoder.

The type of data forming the reconstructed data group (data_type_idx) and the number of feature maps from which data forming the reconstructed data group is extracted (num_of_data_in_datagroup_minus1) may be parsed in a data group header (data_group_header). When the type of the data is a feature map or a transform coefficient, the index of the feature map (FM_idx) included in the reconstructed data may be parsed. When the type of the reconstructed data is a basis vector, the index of a transform unit group (TUG_idx) included in the reconstructed data may be parsed.

When data acquired from multiple feature maps is present in a reconstructed data group, the data may be arranged in the order of indexes of the feature maps therein. The reconstructed data group may be separated into data in units of feature maps using the parsed information, the channel sizes and number of feature maps in the feature map header, and the sizes and number of basis vectors in the transform unit group header. For example, a reconstructed data group configured with the reconstructed transform coefficients of P2 and P3 may be separated into reconstructed transform coefficients of P2 and P3.

Inverse arrangement may be performed on the reconstructed data of each of the separated feature maps. The reconstructed data of each of the separated feature maps may be, for example, the transform coefficient of P2, the basis vector set of TUG1, the feature map of C3, or the the like. Information indicating whether to perform inverse arrangement on the reconstructed data (is_arranged) may be parsed in the data group header, and when inverse arrangement is performed, an inverse arrangement method (arranging_method_idx) may be parsed. Depending on the parsed inverse arrangement method, inverse arrangement may be performed on the reconstructed data.

The feature map information dequantizer 230 may perform dequantization on the reconstructed data output from the feature map information decoder 210 or the feature map information separator 220.

The inverse feature-map transformer 240 performs inverse transformation using the reconstructed transform vector and the reconstructed transform coefficient, thereby reconstructing a feature map.

The reconstructed transform vector to be used for inverse transformation of each feature map may be the transform vector set having the same index as the transform unit group index (TUG_idx) parsed in the feature map header (featuremap_header). Alternatively, the index of the transform unit group in which the current feature map is included may be derived using the feature map index (FM_idx) included in the transform unit group parsed in the transform unit group header (TUG_header). The transform vector set of the transform unit group having the derived index may be used for inverse transformation.

When the transform vector size (basis_vector_size_idx) parsed in the transform unit group header (TUG_header) differs from the transform unit size (feature_TU_size_idx) parsed in the feature map header (featuremap_header), inverse transformation may be performed after up-sampling or down-sampling the transform vector so as to have the same size as the transform unit size.

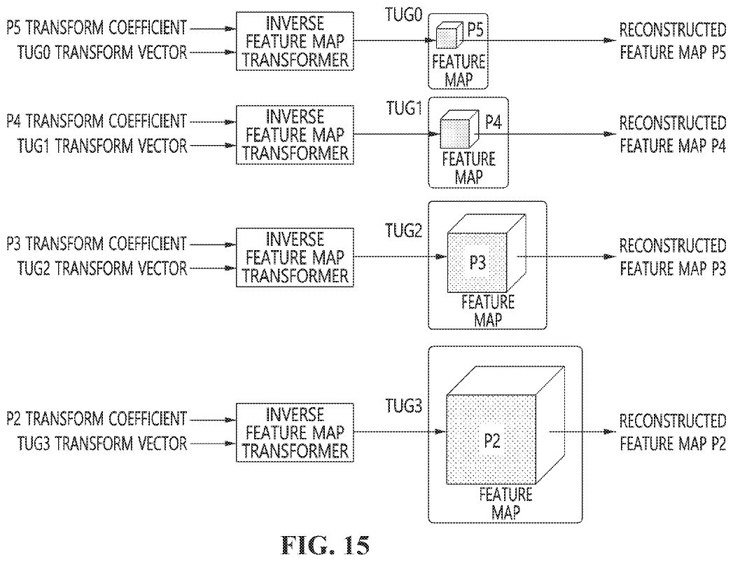

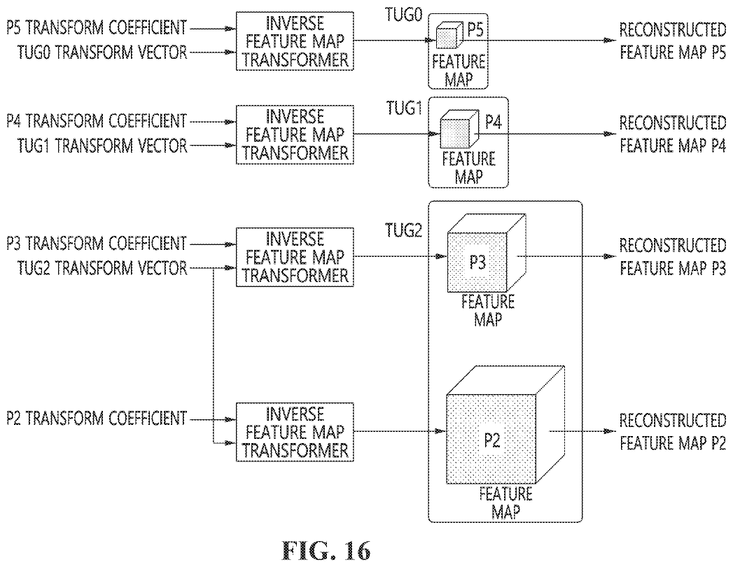

FIGS. 15 to 16 are examples of operation of an inverse feature-map transformer according to different inputs.

As shown in the example of FIG. 15, four feature maps having different resolutions may be transform unit groups. The reconstructed transform coefficient of each of the feature maps may be input to the inverse feature-map transformer of the corresponding feature map. Also, because the feature maps P2, P3, P4, and P5 are included in different transform unit groups, different transform vector sets may be input to the respective inverse feature-map transformers.

As shown in the example of FIG. 16, multiple feature maps having different resolutions may be included in a single transform unit group. Because P2 and P3 are included in a single transform unit group, the same transform vector set may be input to the respective inverse feature-map transformers of P2 and P3.

The feature map generator 250 may generate one or multiple arbitrary feature maps that are not transmitted to the decoder, among the feature maps in the structure of the feature map extraction unit of the neural network, and may use a reconstructed feature map in the generation process.

According to an embodiment, the feature map that is not received and is to be generated by the feature map generator 250 may be the feature map of the same layer as the layer of the reconstructed feature map, or the feature map of the previous or subsequent layer of the layer of the reconstructed feature map.

According to an embodiment, the feature map of the same layer as the layer of the reconstructed arbitrary feature map may be generated by up-sampling or down-sampling the reconstructed feature map.

According to an embodiment, the feature map of the previous layer of the layer of the reconstructed arbitrary feature map may be generated by adding a predicted feature map, which predicts the feature map of the previous layer using the reconstructed feature map, and the received residual feature map.

According to an embodiment, the feature map of the subsequent layer of the layer of the reconstructed arbitrary feature map may be generated by performing the same process as the remaining extraction process of the feature map extraction unit of the neural network of the encoder by using the reconstructed feature map or the feature map of the previous layer generated by the feature map generator.

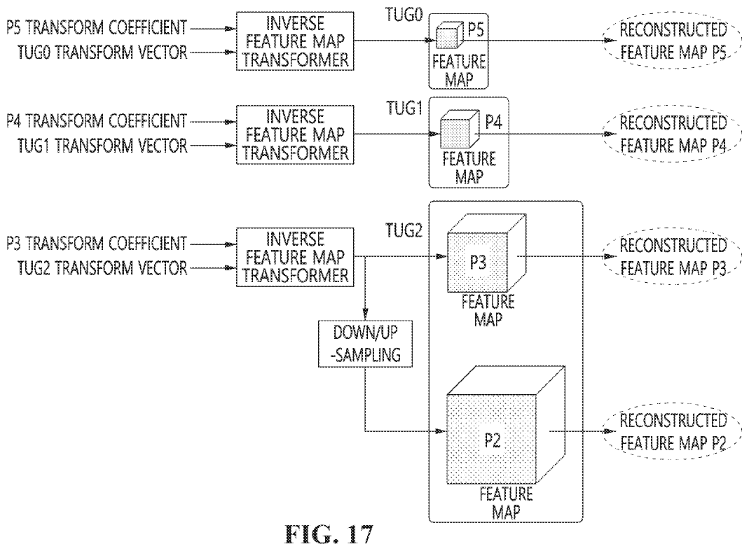

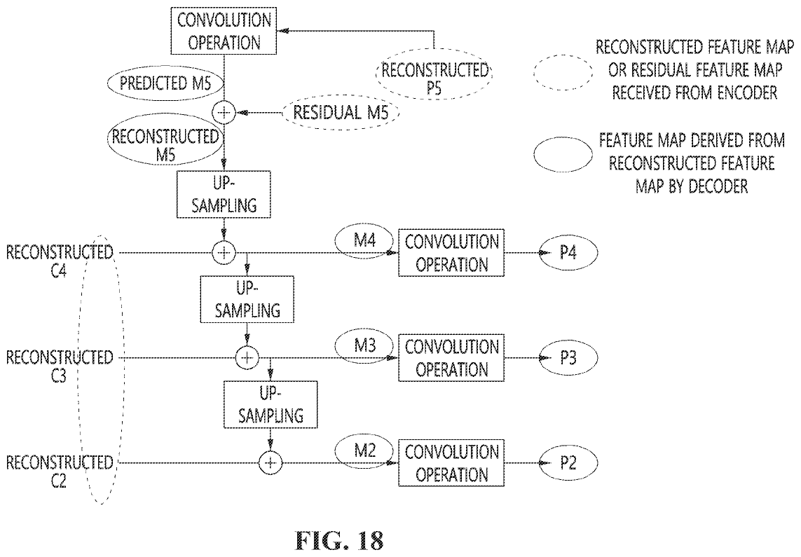

FIG. 17 and FIG. 18 are examples of generation of other feature maps using a feature map reconstructed in a decoder.

As in the example of FIG. 17, using a reconstructed feature map, a feature map of another level in the same layer may be generated without receiving the same. According to an embodiment, feature map P2 may be generated by up-sampling or down-sampling the reconstructed feature map P3.

As in the example of FIG. 18, the feature map of the previous layer of the reconstructed feature map may be generated. According to an embodiment, M5, which is a predicted feature map of the previous layer of the reconstructed P5, is generated by performing the convolution operation of one or multiple layers on the reconstructed feature map P5 and added to the reconstructed residual feature map of M5, whereby a reconstructed feature map M5 may be generated. Using the generated feature map M5 and the reconstructed feature maps C4. C3, and C2, the feature maps M4, M3, M2, P4, P3 and P2 of the feature map extraction unit that are not received may be generated.

The feature map analyzer 260 analyzes the feature map of the neural network using the reconstructed feature map or the feature map generated from the reconstructed feature map, thereby outputting a machine task analysis result. The feature map analyzer may be configured with one or more convolutional layers.

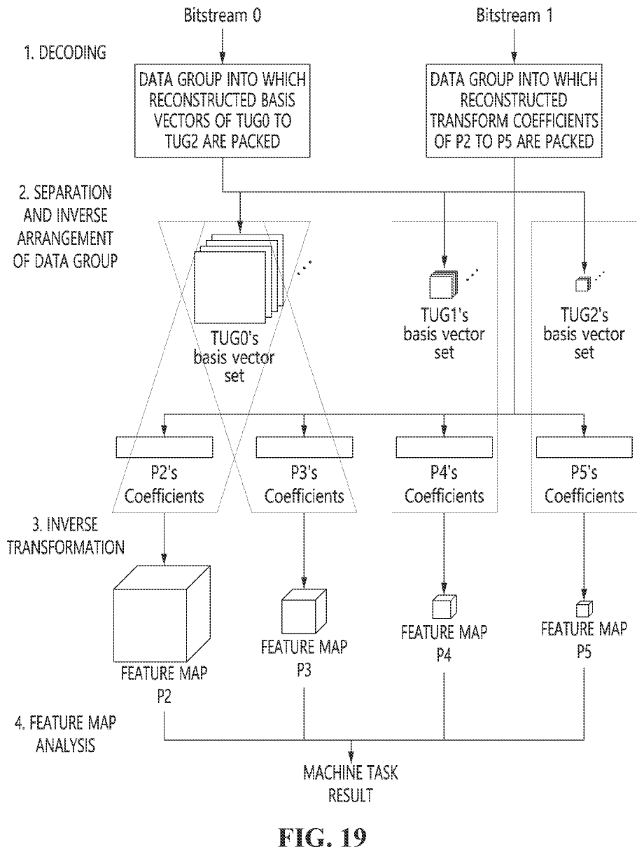

Hereinafter, a decoding process according to an embodiment of the present invention will be described in detail with reference to FIG. 19 and tables.

FIG. 19 is a view conceptually illustrating a decoding process according to an embodiment of the present invention.

Here, information of a data group header (data_group_header) may be used in the decoding process and the data group separation and inverse arrangement process illustrated in FIG. 19, and information of a transform unit group header (TUG_header) and a feature map header (featuremap_header) may be used in the data group separation and inverse arrangement process and the inverse transformation process illustrated in FIG. 19.

Table 1 below illustrates the configuration of the syntax of a data group header.

A transmission edge may extract one or more feature maps from an input image or video. Through the processes of transforming, quantizing, and encoding the one or more feature maps, one or more bitstreams may be output. A single bitstream may include a single encoded data group into which the same kind of data generated from one or multiple feature maps is packed. For example, a data group into which the coefficients of P2, P3, and P4 are packed may be encoded in a single bitstream. In another example, a data group into which the respective basis vector sets of TUG0 and TUG1 are packed may be encoded in a single bitstream. data_group_header may be transmitted for each bitstream.

TABLE 1

| | Descriptor |
|---|---|
| data_group_header( ) { | |
| codec_type_idx | ue(v) |
| is_arranged | u(1) |
| if(is_arranged) | |
| arranging_method_idx | ue(v) |
| data_type_idx | ue(v) |
| num_of_data_in_data_group_minus1 | |
| for(num_of_data_in_data_group_minus1 + 1) | |
| { | |
| if(data_type_idx == FEATURE MAP) | |
| FM_idx[ i ] | ue(v) |
| else if(data_type_idx == COEFFICIENT) | |
| FM_idx[ i ] | ue(v) |
| else if(data_type_idx == BASIS VECTOR) | |
| TUG_idx[ i ] | ue(v) |
| } | |
| } | |

A description of the syntax configuration of Table 1 above is as follows.

codec_type_idx is the index of a codec type for decoding,

0=codec based on prediction and transformation, 1=codec based on end-to-end deep-learning, 2=codec based on entropy coding.

is_arranged indicates whether to perform inverse arrangement on data in a data group reconstructed by decoding a corresponding bitstream using a feature map information decoder,

0=inverse arrangement is not performed, 1=inverse arrangement is performed.

arranging_method_idx is the index of an inverse data arrangement method.

data_type_idx is the index of the type of data reconstructed from a corresponding bitstream,

0=feature map, 1=transform coefficient, 2=basis vector.

num_of_data_in_data_group_minus1 is the number of feature maps or TUGs from which data included in a data group reconstructed from a corresponding bitstream is derived.

For example, when the transform coefficients of three feature maps P2, P3 and P4 are included in a data group, the value of the syntax may be 2.

For example, when the respective basis vector sets of TUG1 and TUG2 are included in a data group, the value of the syntax may be 1.

FM_idx is the index of each feature map when feature maps or transform coefficients are included in a corresponding bitstream.

TUG_idx is the index of each TUG when a transform vector set is included in a corresponding bitstream.

Table 2 below illustrates the configuration of the syntax of a feature map parameter set.

A feature map parameter set (featuremap_parameter_set) may be transmitted for each image or video input to a transmission edge, and the number of feature maps that are extracted from the image or video and encoded and the respective indexes thereof may be transmitted.

TABLE 2

| | Descriptor |
|---|---|
| featuremap_parameter_set( ) | |
| { | |
| number_of_coded_FM | ue(v) |
| for(number_of_coded_FM) | |
| FM_idx[ i ] | ue(v) |
| . . . | |
| } | |

A description of the syntax configuration of Table 2 above is as follows.

number_of_coded_FM is the number of feature maps that are encoded for each image or video and transmitted.

FM_idx is the index of a feature map.

Table 3 below illustrates the configuration of the syntax of a transform unit group header.

A transform unit group header (TUG_header) is header information transmitted for each transform unit group. One transform vector set may be transmitted for each transform unit group, and the transform vector set may be configured with multiple transform vectors.

TABLE 3

| | Descriptor |
|---|---|
| TUG_header( ) | |
| { | |
| TUG_idx | |
| basis_vector_size_idx | ue(v) |
| num_of_basis_vector | ue(v) |
| num_of_belongedFM | ue(v) |
| for(num_of_belongedFM) | ue(v) |
| FM_idx[ i ] | |
| . . . | ue(v) |
| } | |

A description of the syntax configuration of Table 3 above is as follows.

TUG_idx is the index of a corresponding transform unit group.

basis_vector_size_idx is the size of one transform vector of a corresponding transform unit group.

Table 4 below is an example of basis_vector_size_idx.

TABLE 4

| basis_vector_ | |
|---|---|
| size_idx | Name of feature map |
| 0 | Same with TU size of the first feature map belonging to |
| | TUG |
| 1 | Same with TU size of the second feature map belonging to |
| | TUG |
| 2 | Same with TU size of the third feature map belonging to |
| | TUG |
| . . . | . . . |

num_of_basis_vector is the number of transform vectors included in the transform vector set of a corresponding transform unit group.

num_of_belongedFM is the number of feature maps included in a corresponding transform unit group.

FM_idx is the index of a feature map included in a corresponding transform unit group.

Table 5 below illustrates the configuration of the syntax of a feature map header.

A feature map header (featuremap_header) is header information transmitted for each feature map.

TABLE 5

| | Descriptor |
|---|---|
| featuremap_header( ) | |
| { | |
| FM_idx | ue(v) |
| channel_size_idx | ue(v) |
| number_of_channel | ue(v) |
| is_residual_coded | u(1) |
| is_transformed | u(1) |
| if(is_transformed) | |
| feature_TU_size_idx | ue(v) |
| TUG_idx | ue(v) |
| has_coefficient | u(1) |
| . . . | |
| } | |

A description of the syntax configuration of Table 5 above is as follows.

FM_idx is the index of a corresponding feature map.

Table 6 below is an example of FM_idx.

TABLE 6

| FM_idx | Name of feature map |
|---|---|
| 0 | C2 |
| 1 | C3 |
| 2 | C4 |
| . . . | . . . |

channel_size_idx is the channel size of a corresponding feature map.

Table 7 below is an example of channel_size_idx.

TABLE 7

| channel_size_idx | Size of channel |
|---|---|
| 0 | 64 × 64 |
| 1 | 128 × 128 |
| 2 | 256 × 256 |
| . . . | . . . |

number_of_channel is the number of channels of a corresponding feature map.

is_residual_coded indicates whether a residual feature map of a corresponding feature map is encoded,

0=the feature map is encoded, 1=the residual feature map is encoded.

is_transformed indicates whether transformation is performed on a corresponding feature map,

0=transformation is not performed on the feature map, 1=transformation is performed on the feature map.

feature_TU_size_idx is the size of a transform unit when transformation is performed on a corresponding feature map.

Table 8 below is an example of feature_TU_size_idx.

TABLE 8

| feature_TU_size_idx | Size of TU |
|---|---|
| 0 | channel size |
| 1 | ¼ of channel size |
| 2 | 1/16 of channel size |
| . . . | . . . |

TUG_idx is the index of a TUG in which a feature map is included when transformation is performed on the feature map.

has_coefficient indicates whether a transform coefficient is encoded and transmitted when transformation is performed on a corresponding feature map.

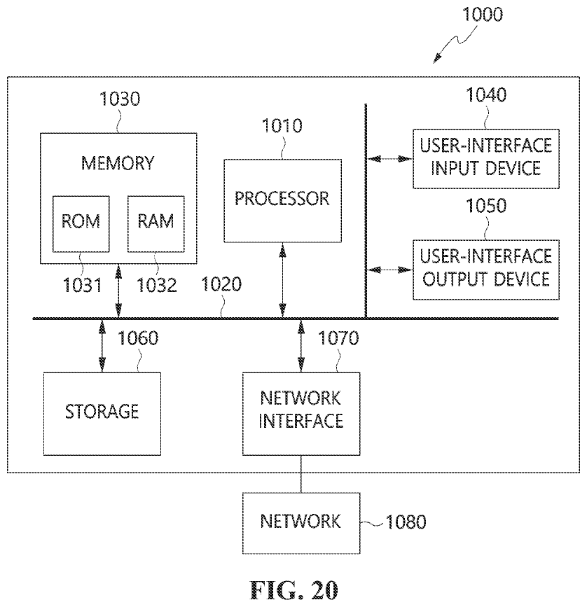

FIG. 20 is a view illustrating the configuration of a computer system according to an embodiment.

The apparatus for encoding/decoding a feature map according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the present invention, a method, apparatus, and recording medium for encoding/decoding a feature map for performing a machine task may be provided.

Also, the present invention may improve encoding and decoding efficiency by reducing the amount of transmitted feature maps or the amount of transmitted basis vectors.

Specific implementations described in the present invention are embodiments and are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. An encoding method, comprising:
generating multiple feature maps using an input image;
transforming the feature maps using a transform vector; and
generating a bitstream by encoding at least any one of the feature map, a transform coefficient of the feature map, or the transform vector, or a combination thereof.

2. The encoding method of claim 1, wherein generating the bitstream includes packing at least any one of the feature map, the transform coefficient of the feature map, or the transform vector, or a combination thereof.

3. The encoding method of claim 1, wherein generating the multiple feature maps comprises using an artificial neural network structure configured with multiple layers.

4. The encoding method of claim 3, wherein generating the multiple feature maps comprises extracting a part of feature maps corresponding to the multiple layers.

5. The encoding method of claim 1, wherein generating the multiple feature maps comprises generating a differential feature map between a predicted feature map and an original feature map.

6. The encoding method of claim 1, wherein:
transforming the feature map includes forming a transform unit group including one or more transform units, and
the transform unit corresponds to a sub-feature map of the feature map.

7. The encoding method of claim 6, wherein the transform vector is set to correspond to the transform unit group.

8. The encoding method of claim 7, wherein transforming the feature map includes down-sampling or up-sampling the transform unit when a size of the transform vector differs from a size of the transform unit.

9. A decoding method, comprising:
reconstructing information about at least any one of a feature map, a transform coefficient of the feature map, or a transform vector, or a combination thereof by decoding a bitstream;
inversely transforming the transform coefficient using a reconstructed transform vector; and
reconstructing multiple feature maps using an inversely transformed feature map.

10. The decoding method of claim 9, wherein reconstructing the information includes separating and inversely arranging a data group in the bitstream.

11. The decoding method of claim 9, wherein reconstructing the multiple feature maps comprises using an artificial neural network structure configured with multiple layers.

12. The decoding method of claim 11, wherein reconstructing the multiple feature maps comprises reconstructing other feature maps using the inversely transformed feature map.

13. The decoding method of claim 9, wherein the feature map corresponds to a differential feature map between a predicted feature map and an original feature map.

14. The decoding method of claim 9, wherein:
inversely transforming the transform coefficient comprises inversely transforming each transform unit group including one or more transform units, and
the transform unit corresponds to a sub-feature map of the feature map.

15. The decoding method of claim 14, wherein the transform vector is set to correspond to the transform unit group.

16. The decoding method of claim 12, wherein reconstructing the multiple feature maps comprises reconstructing other feature maps by up-sampling or down-sampling the inversely transformed feature map.

17. The decoding method of claim 12, wherein reconstructing the multiple feature maps comprises reconstructing other feature maps using a result of performing a convolution operation on the inversely transformed feature map and a residual feature map.

18. A computer-readable recording medium for storing a bitstream:
wherein:
the bitstream includes a transform coefficient of a feature map and a transform vector,
the transform coefficient is inversely transformed using the transform vector,
other feature maps are reconstructed using an inversely transformed feature map,
the transform vector is set to correspond to a transform unit group, and
the transform unit group includes one or more transform units.
